(19) United States
(12) Patent Application Publication
(10) Pub. No.: US 2026/0304382 A1
(43) Pub. Date: Oct. 1, 2026

(54) EFFICIENT PAGING FOR SHORT MESSAGES

(71) Applicant: QUALCOMM Incorporated, San Diego, CA (US)

(72) Inventors: Qing LI, Princeton Junction, NJ (US); Junyi LI, Greentown, PA (US); Igor GUTMAN, Hod HaSharon (IL); Navid ABEDINI, Basking Ridge, NJ (US); Qian ZHANG, Basking Ridge, NJ (US); Tao LUO, San Diego, CA (US)

(21) Appl. No.: 19/569,683

(22) Filed: Mar. 17, 2026

Related U.S. Application Data
(60) Provisional application No. 63/781,255, filed on Mar. 31, 2025.

(51) Int. Cl. H04W 68/02; H04W 4/14

(52) U.S. Cl. CPC H04W 68/02; H04W 4/14

(57) ABSTRACT

Apparatus, methods, and computer program products for wireless communication are provided. An example method may include receiving, from a network node while in a low-power transmission/monitoring mode, a short message indication (SMI) that indicates at least one system information block (SIB) or at least one paging. The example method may further include communicating with the network node based on the SMI.

### CROSS REFERENCE TO RELATED APPLICATION(S)

The present Application for Patent claims priority under 35 U.S.C. § 119 to U.S. Provisional Patent Application No. 63/781,255, filed Mar. 31, 2025 and entitled “LOW POWER PAGING FOR SHORT MESSAGES,” which is assigned to the assignee hereof and hereby expressly incorporated by reference herein in its entirety.

### TECHNICAL FIELD

The present disclosure relates generally to communication systems, and more particularly, to wireless communication systems with paging and system information block (SIB).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a network node while in a low-power transmission/monitoring mode, a short message indication (SMI) that indicates at least one system information block (SIB) or at least one paging. The low-power transmission/monitoring mode may be implemented using a low-power radio (LPR) separated from or integrated with a main radio (MR), a single radio with different operating states, or transmission chains with different power amplifier configurations. Based at least in part on information stored in the at least one memory, the at least one processor, individually or in any combination, is configured to communicate with the network node based on the SMI. Based at least in part on information stored in the at least one memory, the at least one processor, individually or in any combination, is configured to receive, from a network node, a paging message in a common paging occasion (PO), where the common PO is associated with a group of UEs or all UEs in communication with the network node. Based at least in part on information stored in the at least one memory, the at least one processor, individually or in any combination, is configured to communicate with the network node based on the paging message.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit, for one or more UEs, an SMI that indicates at least one SIB or at least one paging. Based at least in part on information stored in the at least one memory, the at least one processor, individually or in any combination, is configured to communicate with the one or more UEs based on the SMI. Based at least in part on information stored in the at least one memory, the at least one processor, individually or in any combination, is configured to transmit, for one or more UEs, a paging message in a common PO, where the common PO is associated with a group of UEs or all UEs in communication with the network node. Based at least in part on information stored in the at least one memory, the at least one processor, individually or in any combination, is configured to communicate with the one or more UEs based on the paging message.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating example low power radio (LPR) device, in accordance with various aspects of the present disclosure.

FIG. 5 is a diagram illustrating an example paging cycle, in accordance with various aspects of the present disclosure.

FIG. 6 is a diagram illustrating example of using short message indication (SMI) for LPR, in accordance with various aspects of the present disclosure.

FIG. 7A is a diagram illustrating example cyclic shifts, in accordance with various aspects of the present disclosure.

FIG. 7B is a diagram illustrating example of on-off keying (OOK) sequences, in accordance with various aspects of the present disclosure.

FIG. 7C is a diagram illustrating example overlay of OOK bit(s), in accordance with various aspects of the present disclosure.

FIG. 8 is a diagram illustrating example of emergency short message, in accordance with various aspects of the present disclosure.

FIG. 9 is a diagram illustrating example of using SMI and subsequently waking up main radio, in accordance with various aspects of the present disclosure.

FIG. 10 is a diagram illustrating example communications between a network node and a UE, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity, in accordance with various aspects of the present disclosure.

FIG. 16 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

In some wireless communication systems, in higher connection density areas, broadcasted short messages may be repeated on many different paging occasions associated with many different user equipments (UEs). In particular, for higher peak data rate and higher spectral efficiency, the broadcast short messages may be repeated on more beams. Therefore, each UE may use more time for beam pairing or tuning, resulting in a higher energy consumption or a higher delay for those short messages.

Some aspects provided herein may improve energy consumption or latency related to paging associated with the short messages (e.g., and in particular emergency messages associated with the short messages) by using a low-power transmission/monitoring mode for cell's short messages. The low-power transmission/monitoring mode may be implemented for more energy efficiency using a low-power radio (LPR), a single radio with different operating states, or transmission chains with low-power power amplifier configurations. In some aspects, a paging synchronization signal burst may be used for reducing the latency for synchronization and beam pairing or tuning. In some aspects, the short message indication (SMI) may be used for saving UE's power. In some aspects, common POs for all UEs may be used for the cell's short messages to save network-side power. In some aspects, the low-power transmission/monitoring mode may be used for transmission of emergency messages to reduce latency in reception of the emergency messages (e.g., because the UE would save time of ramping up (e.g., performing RF calibration, synthesizer locking, and baseband initialization) to an active transmission/monitoring state/mode, which may be a transmission/monitoring state/mode that may use more power (e.g., and may be a default mode for a UE) and use a main radio (MR), a single radio (e.g., same radio) with high power operating states, or transmission chains with high power amplifier configurations. Some aspects provided herein may improve energy consumption or latency related to paging associated with the short messages by using a combination of the active transmission/monitoring mode and the low-power transmission/monitoring mode (which may also be referred to as mixed mode operation) (e.g., allowing the UE to utilize the low-power transmission/monitoring mode for efficient monitoring while leveraging the active transmission/monitoring mode for high-bandwidth data reception). For example, to improve data rate for large short messages (e.g., some of the SIBs), facilitating usage of the combination of the active transmission/monitoring mode and the low-power transmission/monitoring mode for cell's short messages may include: (1) using the paging synchronization signal burst for reducing the latency for synchronization and beam pairing or tuning (e.g., enabling synchronization without fully powering to the active transmission/monitoring mode), (2) using low-power mode SMI for saving UE's power (e.g., maintaining the active transmission/monitoring mode in a sleep state until a relevant message is indicated), (3) using the paging synchronization signal burst for reducing the latency for synchronization and beam pairing or tuning (e.g., providing precise synchronization for high-order modulation decoding), (4) using active-mode common PO(s) for all UEs to save the network's power (e.g., reducing radio resource overhead by broadcasting a single message for multiple UEs), or (5) using the active transmission/monitoring mode for larger system information blocks (SIBs) such as downlink control information (DCI) with paging-radio network temporary identifier (P-RNTI) or paging messages on physical downlink shared channel (PDSCH) with large SIBs (e.g., accommodating data payloads that exceed the bandwidth or processing capabilities of the low-power transmission/monitoring mode).

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements.

For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

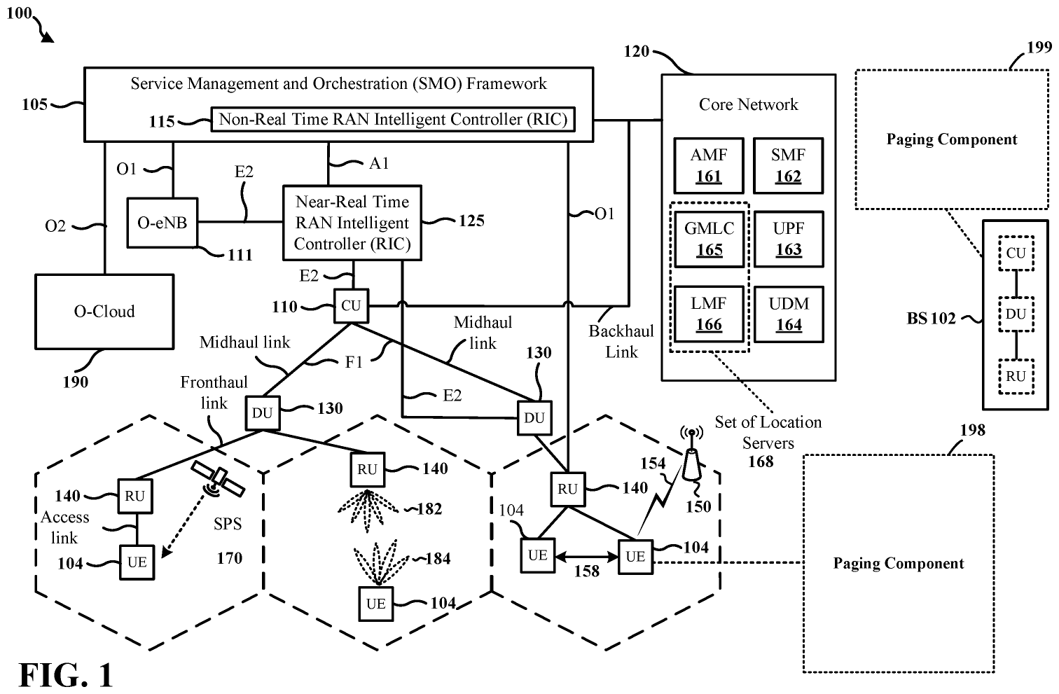

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a paging component 198. In some aspects, the paging component 198 may be configured to receive, from a network node while in a low-power transmission/monitoring mode, a short message indication (SMI) that indicates at least one system information block (SIB) or at least one paging. The low-power transmission/monitoring mode may be implemented for more energy efficiency using a low-power radio (LPR) separated from or integrated with a main radio (MR), a single radio with different operating states, or transmission chains with different power amplifier configurations. In some aspects, the paging component 198 may be further configured to communicate with the network node based on the SMI. In some aspects, the paging component 198 may be configured to receive, from a network node, a paging message in a common paging occasion (PO), where the common PO is associated with a group of UEs or all UEs in communication with the network node. In some aspects, the paging component 198 may be further configured to communicate with the network node based on the paging message.

In certain aspects, the base station 102 may include a paging component 199. In some aspects, the paging component 199 may be configured to transmit, for one or more UEs (e.g., a group of UEs or all UEs in communication with the network node), an SMI that indicates at least one SIB or at least one paging. In some aspects, the paging component 199 may be further configured to communicate with the one or more UEs based on the SMI. In some aspects, the paging component 199 may be configured to transmit, for one or more UEs (e.g., a group of UEs or all UEs in communication with the network node), a paging message in a common PO, where the common PO is associated with a group of UEs or all UEs in communication with the network node. In some aspects, the paging component 199 may be further configured to communicate with the one or more UEs based on the paging message.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

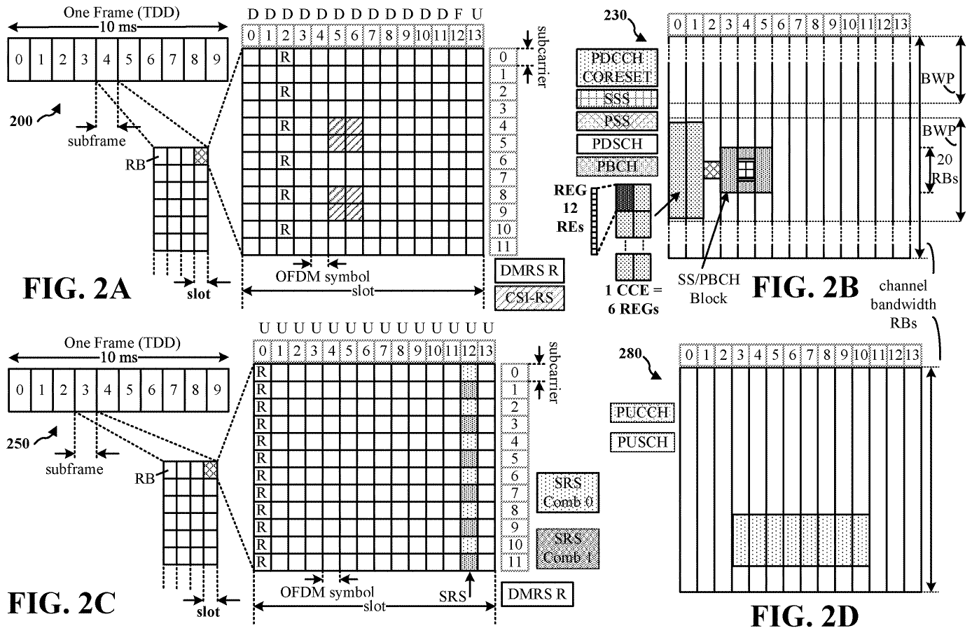

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

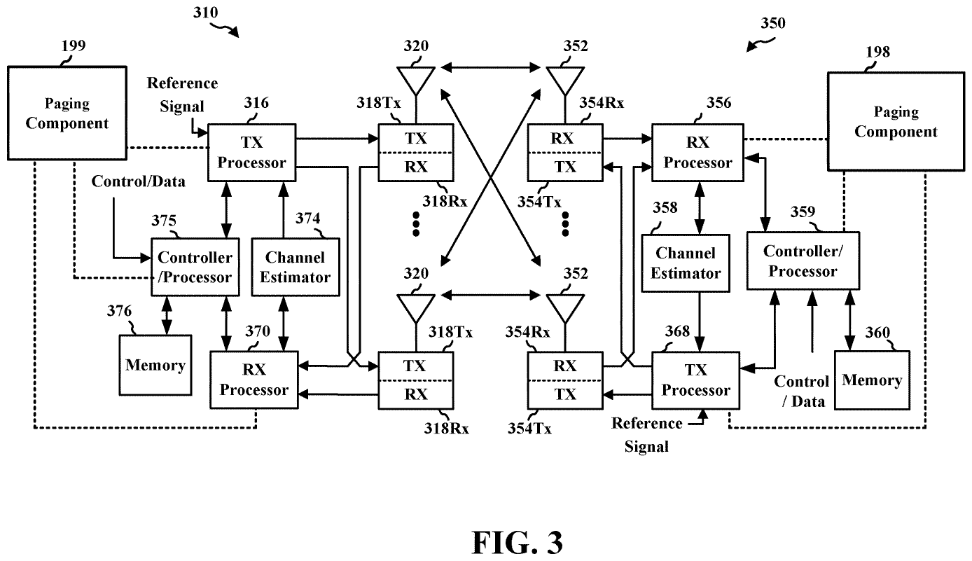

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, onto mapping physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with paging component 198 of FIG. 1.

At least one of the TX processor 316, the RX processor 370, and the controller/processor 375 may be configured to perform aspects in connection with paging component 199 of FIG. 1.

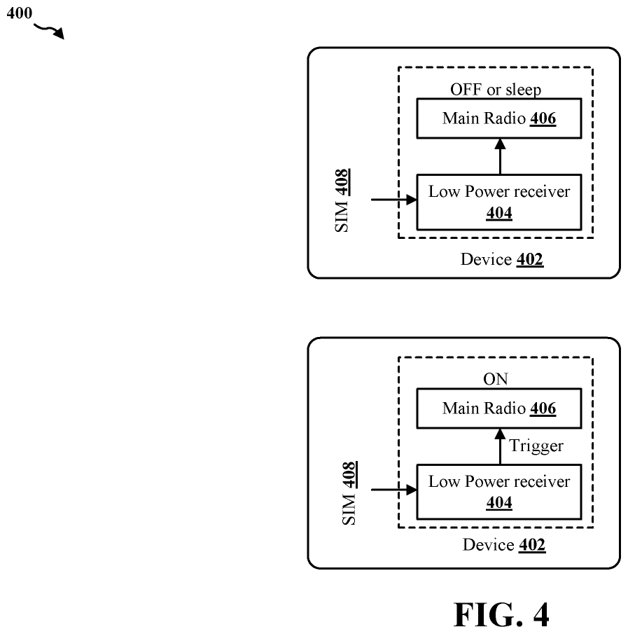

A low-power transmission/monitoring mode may be implemented using a low-power radio (LPR), which may be a radio receiver circuit (and may be an envelope detector) with a low energy consumption. An LPR may be a receiver circuit utilizing a non-coherent detection architecture or a coherent detection architecture with relaxed synchronization specifications which may not involve complex channel estimation or phase tracking compared to an active transmission/monitoring mode (e.g., implemented using a main radio (MR)). FIG. 4 is a diagram 400 illustrating example device 402 (such as an active UE) with an LPR as an example implementation of the low-power transmission/monitoring mode. The active UE may use the low-power transmission/monitoring mode (e.g., implemented via the LPR) to dynamically activate the active transmission/monitoring mode (e.g., implemented via main radio 406) for reducing power consumption. When there is no data to receive, main radio 406 may be off unless there is something to transmit. The low-power transmission/monitoring mode may wake up more frequently for monitoring an SMI 408 with low power. When an SMI 408 is detected during the wake-up time, the low-power transmission/monitoring mode may receive and decode the SMI 408 via the low power receiver 404 and activate the active transmission/monitoring mode (e.g., based on the SMI 408 received). Data or messages may be transmitted and received by the active transmission/monitoring mode (e.g., via the main radio 406). Such a low-power transmission/monitoring mode may enable frequent SMI monitoring to meet a latency specification (e.g., emergency messages) and may present low energy consumption compared to the active transmission/monitoring mode with frequent wakeup. That is such a low-power transmission/monitoring mode may avoid excessive active transmission/monitoring mode wakeup for paging monitoring, especially for broadcasting paging (e.g., emergency messages, system information updates, and alike).

A paging message may include a cell's broadcast short messages which may include emergency messages, such as an earthquake and tsunami warning system (ETWS) notification, a commercial mobile alert system (CMAS) notification, or public warning system (PWS) alerts. The emergency messages may be subject to a fast delivery specification (e.g., within a latency threshold such as four seconds). There may be different types of SIBs. For example, SIB 1 may be broadcasted by a network node to provide cell access parameters, scheduling of other SIBs, public land mobile network (PLMN) identities, and configuration for initial access, random access channel (RACH) configuration, UL power control, and UP bandwidth part (BWP) configurations. SIB2 may provide cell re-selection information, mainly related to the serving cell. SIB 3 may include the serving frequency and intra-frequency neighboring cells relevant for cell reselection parameters. SIB 4 may include other NR frequencies and inter-frequency neighboring cells relevant for cell reselection, which can also be used for NR idle/inactive measurements. SIB 5 may include information for E-UTRA frequencies and E-UTRA neighboring cells relevant for inter-RAT cell reselection including relevant carrier frequencies and reselection priorities. SIB 9 may include time and frequency synchronization information related to GPS time and Coordinated Universal Time (UTC). SIB 10 may include Human-Readable Network Names (HRNN) of the NPNs listed in SIB1. SIB11 may include information related to idle/inactive measurements; SIB 12 may include information related to NR sidelink communication, ranging and sidelink positioning. SIB 17 and SIB17bis may include information related to TRS configuration for UEs in an RRC idle or RRC inactive state (RRC_IDLE/RRC_INACTIVE). SIB19 may include NTN-specific parameters for serving cell and optionally NTN-specific parameters for neighbor cells. As another example, SIB 6 and SIB 7 may provide ETWS primary notification and ETWS secondary notification, and SIB 8 may provide CMAS notification.

An example paging message may include a cell's broadcast short messages including emergency messages, such as SIBs related to ETWS primary notification, ETWS secondary notification, CMAS notification, or PWS notification. The cell's broadcast short message may also indicate system information modification for other SIBs. An example paging message may also include unicast DL traffic paging for a UE. As an example, a UE may be configured with a default discontinuous reception (DRX) cycle for waking up to check paging early indication (PEI) or paging indication (PI). An example DRX cycle may be based on a defined formula, such as (T div N)*(UE_ID mod N), where T=min {default DRX, RRC configured DRX, upper layer configured DRX}. The default DRX is upper bounded with 256 radio frames (i.e., UE's sleep time <2.56 seconds). In some implementations, the default DRX cycle may be configured with 128 radio frames, which means that a UE may wake up almost every second for emergency messages, which may rarely occur. The network may also repeat the same short messages at each UE's paging occasion (PO) on each beam. A paging frame (PF) is a specific radio frame in which a UE may expect to monitor for a paging message. A PO may be a specific subframe or slot within the PF where the actual paging message may appear.

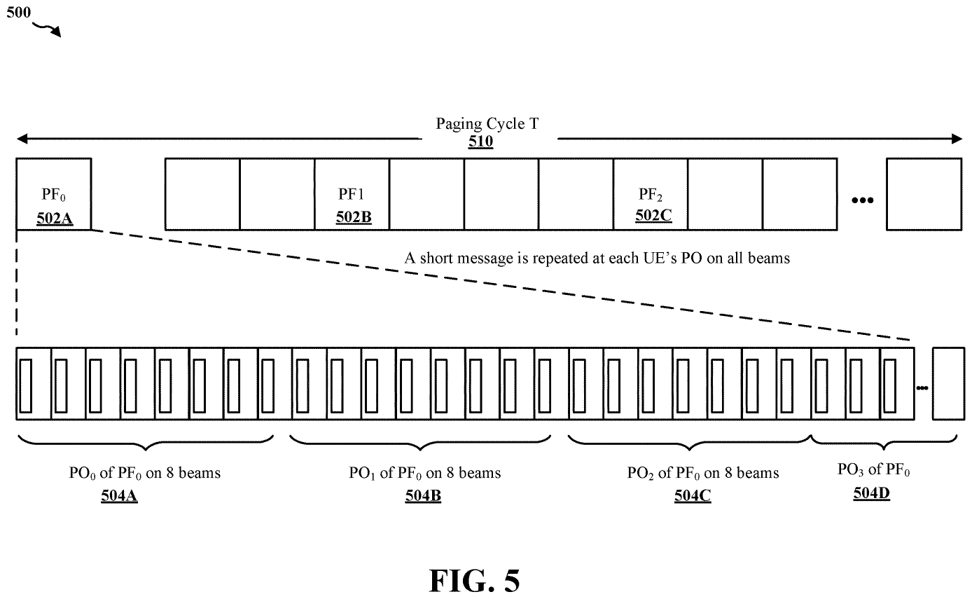

FIG. 5 is a diagram 500 illustrating an example paging cycle 510, in accordance with various aspects of the present disclosure. As illustrated in FIG. 5, within the paging cycle 510, there may be a first PF 502A, a second PF 502B, and a third PF 502C. Each of the first PF 502A, the second PF 502B, and the third PF 502C may include multiple POs. For example, the first PF 502A may include a first PO 504A repeated on each of eight beams associated with the network node, a second PO 504B repeated on each of eight beams associated with the network node, a third PO 504C repeated on each of eight beams associated with the network node, and a fourth PO 504D repeated on each of eight beams associated with the network node.

Compared with 4G LTE, some other wireless communication systems (e.g., 5G NR) may have a higher latency before a UE monitors its PO due to the latency of searching for sparse SSB transmissions and beam pairing/tuning. In some wireless communication systems, emergency messaging may be delivered through paging with short messages. These short messages may be transmitted on the PDCCH using the paging-radio network temporary identifier (P-RNTI), and may be accompanied by a longer paging message or sent alone. The paging downlink control information (DCI) (e.g., DCI format 1_0) may include an indicator field (e.g., 2 bits) that signals whether the DCI contains paging information without short message information, short message information without paging information, or both. The short messages field (e.g., 8 bits) encodes emergency indicators, such as system information modification indicator (e.g., represented by systemInfoModification (bit 1)), which indicates a BCCH change excluding SIB6, SIB7, and SIB8, and ETWS and CMAS indication (e.g., represented by etwsAndCmasIndication (bit 2)), which signals the presence of ETWS primary/secondary or CMAS notifications. The DCI may also include fields for frequency domain resource assignment, time domain resource assignment, virtual resource block (VRB)-to-PRB mapping, modulation and coding scheme (MCS), and transport block scaling. For the emergency paging messages themselves, SIB 6, SIB 7, and SIB 8 may be used. Each carries ETWS and CMAS warning information such as the message identifier (e.g., represented by messageIdentifier), serial number (represented by serialNumber), warning type (represented by warningType), warning message segment (e.g., represented by warningMessageSegment), and other optional fields including the MCS (e.g., represented by dataCodingScheme) and whether there is extension (e.g., represented by lateNonCriticalExtension). These SIBs may facilitate delivery of public warnings even when other broadcast channels may not be available.

In some wireless communication systems, in higher connection density areas, broadcasted short messages may be repeated on many different paging occasions associated with many different user equipments (UEs). In particular, “large-scale antenna systems and massive beamforming arrays (e.g., mega MIMO) may be used for higher peak data rate and higher spectral efficiency, the broadcast short messages may be repeated on more beams. Therefore, each UE may use more time for beam pairing or tuning, resulting in a higher energy consumption or a higher delay for those short messages.

Some aspects provided herein may improve energy consumption or latency related to paging associated with the short messages (e.g., and in particular emergency messages associated with the short messages) by using a low-power transmission/monitoring mode (e.g., implemented using a low-power radio (LPR), implemented based on adjusting modes of transmission of a same radio or different radios, or the like) for cell's short messages. In some aspects, a paging synchronization signal burst may be used for reducing the latency for synchronization and beam pairing or tuning. In some aspects, low-power mode short message indication (SMI) may be used for saving UE's power. In some aspects, common POs for all UEs may be used for the cell's short messages to save network-side power. In some aspects, the low-power transmission/monitoring mode may be used for transmission of emergency messages to reduce latency in reception of the emergency messages (e.g., because the UE would save time of ramping up to the active transmission/monitoring mode (e.g., implemented using a main radio (MR), implemented based on adjusting modes of transmission of a same radio or different radios, or the like)). Some aspects provided herein may improve energy consumption or latency related to paging associated with the short messages by using a combination of the active transmission/monitoring mode and the low-power transmission/monitoring mode (which may also be referred to as mixed mode operation). For example, to improve data rate for large short messages (e.g., some of the SIBs), facilitating usage of the combination of the active transmission/monitoring mode and the low-power transmission/monitoring mode for cell's short messages may include: (1) using a paging synchronization signal burst for reducing the latency for synchronization and beam pairing or tuning, (2) using low-power mode SMI for saving UE's power, (3) using the paging synchronization signal burst for reducing the latency for synchronization and beam pairing or tuning, (4) using active-mode common PO(s) for all UEs to save the network's power, or (5) using the active transmission/monitoring mode for larger system information blocks (SIBs) such as downlink control information (DCI) with paging-radio network temporary identifier (P-RNTI) or paging messages on physical downlink shared channel (PDSCH) with large SIBs.

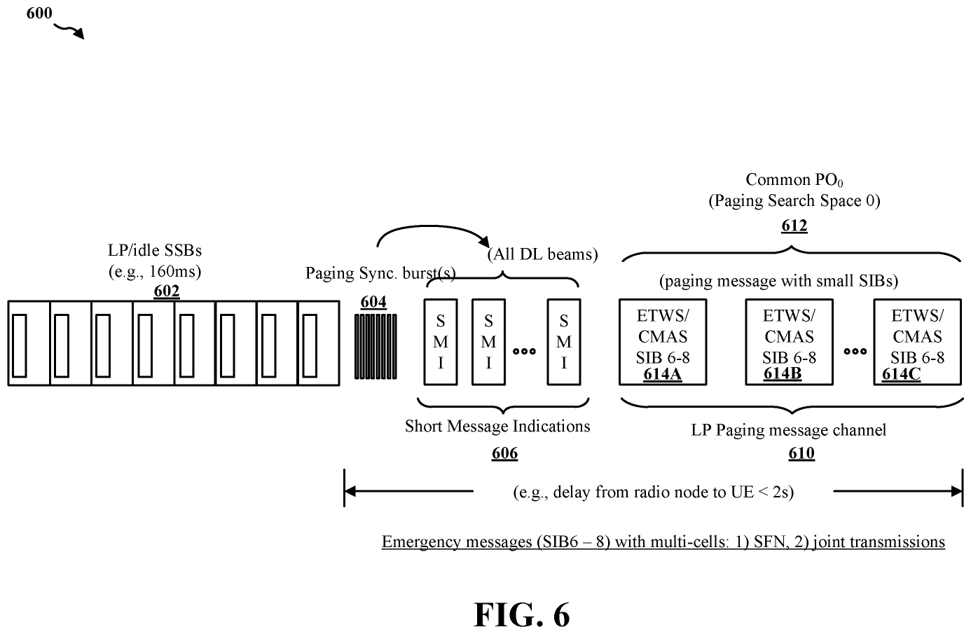

FIG. 6 is a diagram 600 illustrating example of using SMI for a low-power transmission/monitoring mode, in accordance with various aspects of the present disclosure. As illustrated in FIG. 6, a set of low-power (LP) SSBs 602 may be transmitted from a network node to a UE to enable synchronization while the UE is in a low-power transmission/monitoring mode (e.g., implemented using an LPR, implemented based on adjusting modes of transmission of a same radio or different radios, or the like) without transitioning to an active transmission/monitoring mode (e.g., implemented using an MR, implemented based on adjusting modes of transmission of a same radio or different radios, or the like). In some aspects, the network node may also transmit one or more paging synchronization signal (e.g., that may be suitable for the low-power transmission/monitoring mode and the active transmission/monitoring state/mode) bursts 604 (e.g., synchronization signal transmissions on all down link beams in each burst). Additionally, the one or more paging synchronization signal (e.g., that may be suitable for the low-power transmission/monitoring mode and the active transmission/monitoring state/mode) bursts 604 may also be used as an early indication for SMI (e.g., an early indication to UEs that SMI(s) 606 may be transmitted subsequently). The SMI transmissions may be associated with all downlink beams for the low-power transmission/monitoring mode. For example, a first SMI may be transmitted with a first DL beam associated with a first idle state SSB or a first paging synchronization signal (e.g., that may be suitable for the low-power transmission/monitoring mode and the active transmission/monitoring state/mode) transmission within a burst (e.g., QCL type D or same spatial filter) and received with a first best receiving beam corresponding to the first idle state SSB or the first paging synchronization signal (e.g., that may be suitable for the low-power transmission/monitoring mode and the active transmission/monitoring state/mode) transmission within a burst, a second SMI may be transmitted with a second DL beam associated with a second idle state SSB or a second paging synchronization signal (e.g., that may be suitable for the low-power transmission/monitoring mode and the active transmission/monitoring state/mode) transmission within a burst (e.g., QCL type D or same spatial filter) and received with a second best receiving beam corresponding to the second idle state SSB or the second paging synchronization signal (e.g., that may be suitable for the low-power transmission/monitoring mode and the active transmission/monitoring state/mode) transmission within a burst, and so on. UEs may monitor and receive SMI(s) 606 while in the low-power transmission/monitoring mode of the UE after synchronized and beam-paired or beam-tuned with the one or more paging synchronization signal (e.g., that may be suitable for the low-power transmission/monitoring mode and the active transmission/monitoring state/mode) bursts 604 (e.g., using one or more best selected or paired receiving beam(s) for the low-power transmission/monitoring mode). UE may skip monitoring SMI(s) 606 and go to sleep immediately if no one or more paging synchronization signal (e.g., that may be suitable for the low-power transmission/monitoring mode and the active transmission/monitoring state/mode) bursts 604 transmitted. The SMI(s) 606 may indicate messages in an LP paging message channel 610, for short messages such as ETWS or CMAS (or other emergency notification) messages in various SIB types (e.g., SIB 6 to SIB 8), including a first emergency notification message 614A on a first beam associated with a first idle state SSB or a first paging synchronization signal (e.g., that may be suitable for the low-power transmission/monitoring mode and the active transmission/monitoring state/mode) transmission within a burst (e.g., QCL type D or same spatial filter), a second emergency notification message 614B on a second beam associated with a second idle state SSB or a second paging synchronization signal (e.g., that may be suitable for the low-power transmission/monitoring mode and the active transmission/monitoring state/mode) transmission within a burst, and a third emergency notification message 614C on a third beam associated with a third idle state SSB or a third paging synchronization signal (e.g., that may be suitable for the low-power transmission/monitoring mode and the active transmission/monitoring state/mode) transmission within a burst, and so on. The messages in the LP paging message channel 610, including the first emergency notification message 614A on a first beam associated with a first idle state SSB or a first paging synchronization signal (e.g., that may be suitable for the low-power transmission/monitoring mode and the active transmission/monitoring state/mote) transmission within a burst (e.g., QCL type D or same spatial filter), the second emergency notification message 614B on a second beam associated with a second idle state SSB or a second paging synchronization signal (e.g., that may be suitable for the low-power transmission/monitoring mode and the active transmission/monitoring state/mode) transmission within a burst, and the third emergency notification message 614C on a third beam associated with a third idle state SSB or a third paging synchronization signal (e.g., that may be suitable for the low-power transmission/monitoring mode and the active transmission/monitoring state/mode) transmission within a burst, and so on. The emergency notification messages 614A-614C may be transmitted on a common PO 612 that may be common for a group of UEs or all UEs in communication with the network node (e.g., allowing the network node to transmit a single paging message for multiple UEs simultaneously rather than repeating transmissions for individual UE-specific paging occasions).

In some aspects, an SMI may indicate at least one (or one) of: ETWS primary notification, ETWS secondary notification, CMAS notification, idle/inactive state SIBs (e.g., SIBs for UEs at RRC idle or inactive state for monitoring neighboring cells or RAN tracking such as a subset parameters of SIB 1 for idle/inactive UEs (e.g., SIB11, for example, the information needed for at least cell selection or reselection (e.g., a suitable cell selection)), SIB 2-SIB 4, SIB 11, SIB 17, or the like), connected SIBs (e.g., SIBs for UEs transferring to RRC connected state using RRC reestablishment or RRC resume such as a subset parameters of SIB 1 (e.g., SIB1c) for making RRC connect or resuming RRC connect (e.g., parameters of PRACH) and other SIBs), feature SIBs such as SIBs for some features or verticals (e.g., SIB 12 for sidelink, SIB 23 for ranging and sidelink positioning, SIB 19 for NTN-specific parameters, or the like), other (e.g., paging such as broadcast or groupcast paging or PEI for unicast paging), or that the SMI may be extended with a subsequent SMI segment transmission, which may further indicate an ID for a broadcast or groupcast paging or a bitmap associated with subgroup IDs (e.g., as used for PEI) when paging is indicated.

In some aspects, the UE may monitor SMI during an SMI monitoring window, which may be configured based on: a starting point in the time domain (e.g., a time offset specified or configured after the idle/inactive state SSB or paging synchronization signal burst), a duration in the time domain which may be one or more window sizes (e.g., based on the number of beams for SMI transmissions), a starting point in the frequency domain (e.g., same as or shifted from the starting PRB of idle/inactive state SSB or paging synchronization signal burst), or a BWP, such as a narrow band for low power operation, which may be the same or different from the initial BWP.

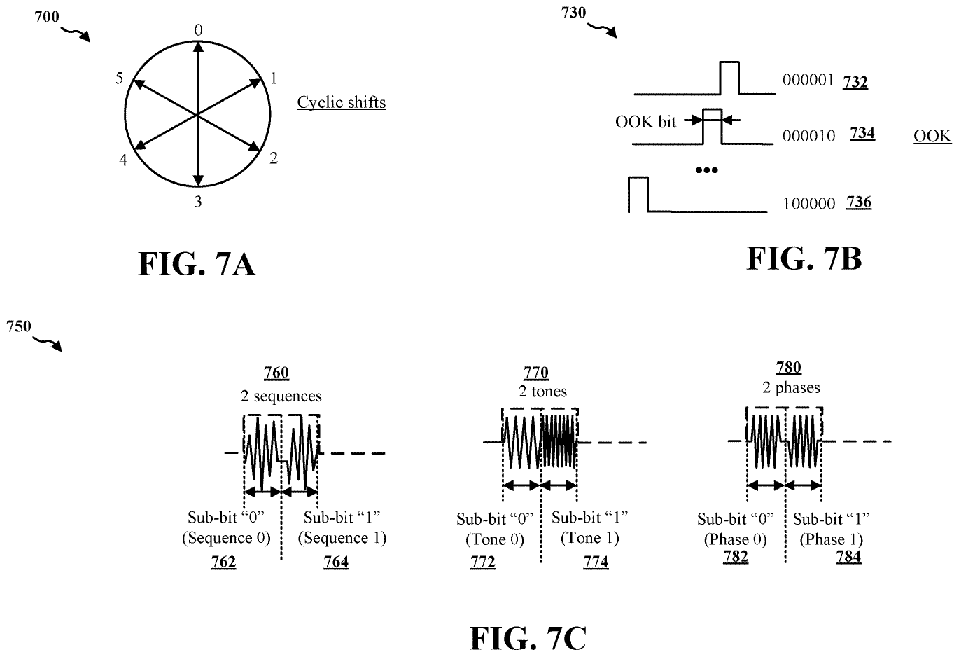

In some aspects, the SMI may be based on one or more OFDM sequences. FIG. 7A is a diagram 700 illustrating example cyclic shifts with one or more OFDM sequences, in accordance with various aspects of the present disclosure. As illustrated in FIG. 7A, the six cyclic phase positions may be mapped to a bitmap associated respectively with six different types of SMIs depending on what the SMI indicates. In some aspects, multiple sequences (with or without cyclic shifting) may be mapped to a bitmap associated respectively with different types of SMIs. An example of the bitmap is illustrated in the following table:

TABLE 2
example mapping of cyclic shift phase and SIB type

| Phase 0 | Phase 1 | Phase 2 | Phase 3 | Phase 4 | Phase 5 |
|---|---|---|---|---|---|
| ETWS primary | ETWS secondary | CMAS | RRC Idle/Inactive | RRC Connected | Feature |
| notification | notification | notification | SIBs (e.g., SIB1_{I}, | SIBs (e.g., SIB1_{C}, | SIBs |
| (SIB6) | (SIB7) | (SIB8) | SIB2-4, or the like) | other SIBs,) | (e.g., SIB12) |

In some aspects, the SMI may be based on an on-off keying (OOK) with bitmap. For example, different OOK bits may be mapped to a bitmap associated respectively with SMI.

FIG. 7B is a diagram 730 illustrating example of OOK sequences, in accordance with various aspects of the present disclosure. A first OOK sequence 732 may be mapped to a first SMI type, a second OOK sequence 734 may be mapped to a second SMI type, and a third OOK sequence 736 may be mapped to a third SMI type. An example bitmap is provided in the table below:

TABLE 3
example mapping of indication and OOK bits

| 000001 | 000010 | 000100 | 001000 | 010000 | 100000 |
|---|---|---|---|---|---|
| ETWS primary | ETWS secondary | CMAS | RRC Idle/Inactive | RRC Connected | Feature |
| notification | notification | notification | SIBs (e.g., SIB1_{I}, | SIBs (e.g., SIB1_{C}, | SIBs |
| (SIB6) | (SIB7) | (SIB8) | SIB2-4, or the like) | other SIBs,) | (e.g., SIB12) |

In some aspects, the bitmap may be a fixed size bitmap. In some aspects, each OOK sequence (combination of bits) may indicate one or more types of SIBs being indicated by the SMI. For example, “000011” may indicate ETWS primary (SIB 6) and secondary notification (SIB 7). In some aspects, “011000” may indicate both idle/inactive and connected SIBs' updates. In some aspects, an OOK bit may be overlaid with multiple sub-bit waveforms (e.g., two sub-bits).

FIG. 7C is a diagram 750 illustrating example overlay of OOK bit(s), in accordance with various aspects of the present disclosure. As illustrated in FIG. 7C, in a first example 760, an OOK bit may be overlaid with a first sub-bit 762 (associated with a first sequence, e.g., indicating a value of “0”) and a second sub-bit 764 (associated with a second sequence, e.g., indicating a value of “1”). In a first example 770, an OOK bit may be overlaid with a first sub-bit 772 (associated with a first tone, e.g., indicating a value of “0”) and a second sub-bit 774 (associated with a second tone, e.g., indicating a value of “1”). In a first example 780, an OOK bit may be overlaid with a first sub-bit 782 (associated with a first phase, e.g., indicating a value of “0”) and a second sub-bit 784 (associated with a second phase, e.g., indicating a value of “1”).

In some aspects, the bitmap may be a variable size bitmap (e.g., the size and the mapping may be configured for different UE capabilities or different application or service deployments). In some aspects, the bitmap may be an extendable bitmap that may be used per specification or configuration. An example table illustrates another example bitmap.

TABLE 4
example mapping of indication and OOK bits

| 000001 | 000010 | 000100 | 001000 | 010000 | 100000 |
|---|---|---|---|---|---|
| ETWS primary | RRC Idle/Inactive | RRC Connected | Feature SIBs | Others (e.g., | Extension |
| notification | SIBs: (e.g., SIB1_{I}, | SIBs: (e.g., SIB1_{C}, | (e.g., SIB12) | paging for broad- | |
| (SIB6) | SIB2-4, or the like) | other SIBs,) | | cast/group cast) | |

As illustrated in the table, the sequence “100001” may indicate ETWS primary and secondary notification (SIB 7) without subsequent SMI segment transmission. The sequence “100000” may indicate CMAS notification (SIB 8) without subsequent SMI segment transmission. The sequence “100010” may indicate that the subsequent SMI segment transmission may include one or more specific SIBs of idle/inactive SIBs' updates (e.g., for UEs staying at RRC idle or inactive state). The sequence “100100” may indicate that the subsequent SMI segment transmission may include one or more specific SIBs of connected SIBs' updates (e.g., for UEs transferring to RRC connected state). The sequence “101000” may indicate that the subsequent SMI segment transmission may include one or more specific SIBs of feature SIBs' updates (e.g., an index of a feature SIB or a bitmap of feature SIBs). The sequence “110000” may indicate that the subsequent SMI segment transmission may include an ID for a broadcast/groupcast paging or a bitmap associated with subgroup IDs of UEs (e.g., subgroups as indicated in PEI).

In some aspects, the SMI may be based on OOK with codepoint based on a configuration. For example, the codepoint may be fixed size code point where OOK bits may indicate a codepoint of SMI and additional information based on configuration. An example table of codepoint is provided below:

TABLE 5
example mapping of indication and OOK bits

| Codepoint | Additional content | |
|---|---|---|
| (3~4 bits) | (8~16 bits) | Indication |
| 0001 | NA | ETWS primary notification |
| | | (SIB6) |
| 0010 | NA | ETWS primary and secondary |
| | | notification (SIB6 & SIB7) |
| 0011 | NA | CMAS notification (SIB8) |
| 0100 | Bit-map of | RRC Idle/Inactive SIBs (e.g., |
| | Idle/Inactive SIBs | SIB1_{I}, SIB2-4, or the like) |
| 0101 | Bit-map of | RRC Connected SIBs (e.g., |
| | Connected SIBs | SIB1_{C}, other SIBs,) |
| 0110 | Bit-map of | Feature SIBs |
| | Feature SIBs | (e.g., SIB12 for sidelink, SIB23 |
| | | for ranging & sidelink |
| | | positioning, SIB19 for NTN- |
| | | specific) |
| 0111 | | (reserved) |
| 1000 | Broadcast ID(s) | Broadcast paging |
| 1001 | Groupcast ID(s) | Group paging |
| 1010 | Sub-group ID(s) or | PEI-like indication for one or |
| | bit-map of sub-groups | multiple sub-groups |

In some aspects, a UE may monitor one or more SMIs for tracking SIB updates or SIB status without loading the updated SIBs (e.g., for saving power). For example, a UE may stay RRC Idle or Inactive state and track the SIB updates for RRC connected state (e.g., transferring to RRC connected state via RRC resume from inactive state or RRC re-establishment from idle state) via the SMI indication(s), where the UE may update the corresponding SIB timer (e.g., for validity) based on the SMI indication(s) of the SIB updates for RRC connected state. In this case, the UE may decide if the stored SIBs (e.g., if the UE has stored SIB) for RRC connected state have expired or not and may determine to request on-demand SIB or not when the UE is intending to transfer to RRC connected state.

In some aspects, for the common PO, one common PO may be associated with all types of SMIs. For example, a common PO (PO₀) may be specified or configured for monitoring all short messages which may be spatially associated with the idle/inactive SSB or paging synchronization signals with a periodicity or a monitoring window (e.g., with or without repetition transmissions). In some aspects, multiple common POs associated with respective types of SMIs. For example, a first common PO (PO₀₁) may be specified or configured for monitoring an emergency message (e.g., SIB 6, SIB 7, or SIB 8), which may be spatially associated with the idle/inactive SSB or paging synchronization signals with a first periodicity (e.g., a short period with repetitions for short latency) or a first monitoring window (e.g., with or without repetition transmissions from one or more TRPs or carriers or bandwidths (such as joint or not joint multi-transmissions) or from one or more network cells or nodes (such as Single-Frequency Network (SFN) transmissions)) and a first frequency allocation for LPR or main radio. A second common PO (PO₀₂) may be specified or configured for monitoring idle/inactive SIBs' updates (e.g., SIB1_{I}, SIB2-4, or the like), which may be spatially associated with the idle/inactive SSB or paging synchronization signals with a second periodicity (e.g., associated with SIB update frequency or validity time) or a second monitoring window (e.g., with or without repetition transmissions from one or more TRPs or carriers or bandwidths (such as joint or not joint multi-transmissions) or from one or more network nodes (such as Single-Frequency Network (SFN) for intra-CU transmissions)) and a second frequency allocation for main radio (e.g., same or different from the frequency allocation for Idle/Inactive measurements). A third common PO (PO₀₃) may be specified or configured for monitoring connected SIBs' updates (e.g., SIB1_{IC}, other SIBs, or the like), which may be spatially associated with the Idle/Inactive SSB or paging synchronization signals with a third periodicity (e.g., associated with SIB update frequency or validity time) or third monitoring window (e.g., with or without repetition transmissions from one or more TRPs or carriers or bandwidths or network nodes (such as intra-CU transmissions)) and a third frequency allocation for main radio (e.g., associated with RACH occasion (RO) in time and frequency for fast switching to RRC connected). In some aspects, emergency short message (e.g., ETWS) is supported at a cell (and the cell does not support other types of short message). In this case, the SMI may be followed by immediate transmissions of an emergency short message) or the SMI may include the bit string of an emergency short message (e.g., SIB 6 is contained with the extended SMI segment). In some aspects, idle/inactive state SSBs is supported at an anchor or camp cell (e.g., a coverage cell at low frequency band) (and the cell does not support other types of short message). In this case, the SMI may be followed by the PO for idle/inactive SIBs' updates (e.g., PO₀₂). In some aspects, connected state SSBs is supported at a cell for data transmission or reception (e.g., a capacity cell at high frequency band) (and the cell does not support other types of short message). In this case, the SMI may be followed by the PO for connected SIBs' updates (e.g., PO₀₃).

In some aspects, the one or more common POs may be configured with a common search space, such as search space 0 for paging.

In some aspects, a UE may simultaneously monitor one or more short message transmissions from one or more TRPs or carriers or bandwidths (e.g., joint or not joint multi-transmissions) or one or more network nodes (e.g., SFN transmissions) with one or more respective beams or a wide beam for better reception performance while in the low-power transmission/monitoring mode or the active transmission/monitoring mode (e.g., via the combined signals or messages). In some aspects, a UE may monitor one or more short message transmissions from a TRP of multiple TRs (or a carrier or bandwidth of multiple carriers or bandwidths) of a node or from a network node of multiple network nodes using a selected (e.g., best) receiving beam while in the low-power transmission/monitoring mode or a selected (e.g., best) receiving beam while in the active transmission/monitoring mode (e.g., with the best RSRP or RSRQ measurement of the paging synchronization signal burst(s) using the low-power transmission/monitoring mode or the active transmission/monitoring mode).

In some aspects, a UE may monitor one or more short message transmissions from a TRP of multiple TRs (or a carrier or bandwidth of multiple carriers or bandwidths) of a node or from a network node of multiple network nodes based on its selection of a frequency (e.g., a TRP or carrier or bandwidth of a cell or node or a network cell or node with FR1 or FR2 or FR3).

In some aspects, example low power signaling for emergency short messages may be provided below:

TABLE 6
example content of emergency short messages

| | Message | Serial | Warning Type/ | |
|---|---|---|---|---|
| SIB Type | ID | Number | WarningMessageSegmentType & | DataCodingScheme |
| (2 bits) | (16 bits) | (16 bits) | Number | (optional) (8 bits) |
| SIB6 | yes | yes | Warning Type (2 Oct, i.e., 16 bits) | no |
| (00) | | | | |
| SIB7 | yes | yes | WarningMessageSegmentType (1 bit) | yes |
| (01) | | | WarningMessageSegmentNumber (64 bit) | |
| | | | WarningMessageSegment (Octet string) | |
| SIB8 | yes | yes | WarningMessageSegmentType (1 bit) | yes |
| (10) | | | WarningMessageSegmentNumber (64 bit) | |
| | | | WarningMessageSegment (Octet string) | |

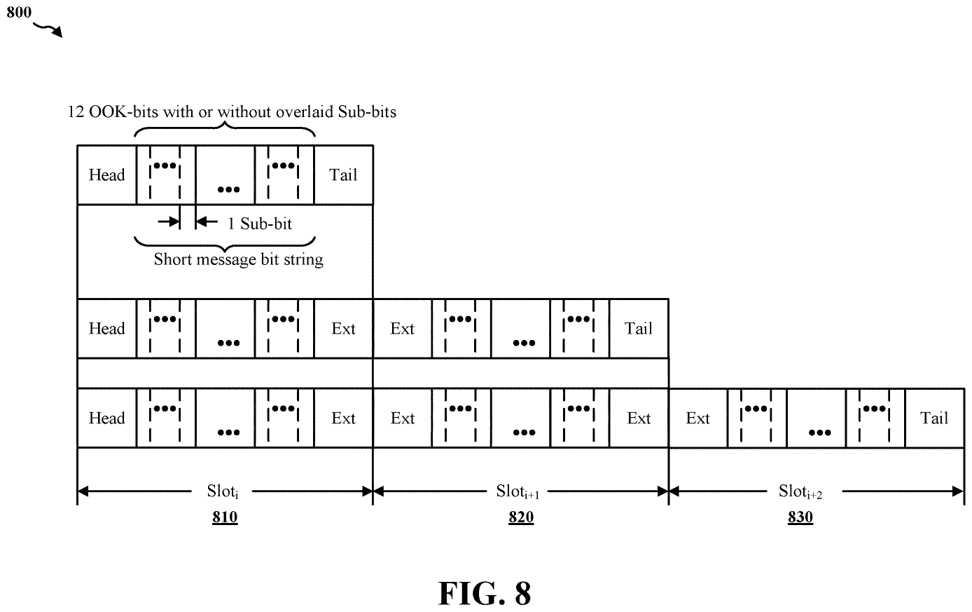

In some aspects, the emergency short message may be transmitted in one slot or multiple slots (e.g., with extended OOK segment transmissions). FIG. 8 is a diagram 800 illustrating example of emergency short message, in accordance with various aspects of the present disclosure. As an example, each “Head” may be a specific OOK-bit with or without secondary modulation (e.g., overlaid sub-bits) for indicating the start of an OOK bit string transmission. Each “Tail” may be a specific OOK-bit with or without secondary modulation (e.g., overlaid sub-bits) for indicating the end of an OOK bit string transmission. Each “Ext” (e.g., for extension) may be a specific OOK-bit with or without secondary modulation (e.g., overlaid sub-bits) for indicating the end of a first OOK bit string transmission with subsequent extended segment transmission or the start of a second OOK bit string transmission containing the extended segment transmission. In some aspects, SIB 6 is transmitted with OOK bit string in one or more contiguous slots, including slot 810, slot 820, and slot 830 (e.g., SIB 7 or SIB 8 may be transmitted with main radio). In some aspects, SIBs 6 and 7 are transmitted contiguously with OOK bit string in multiple contiguous slots. In some aspects, SIB 7 is transmitted with OOK bit string in multiple contiguous slots.

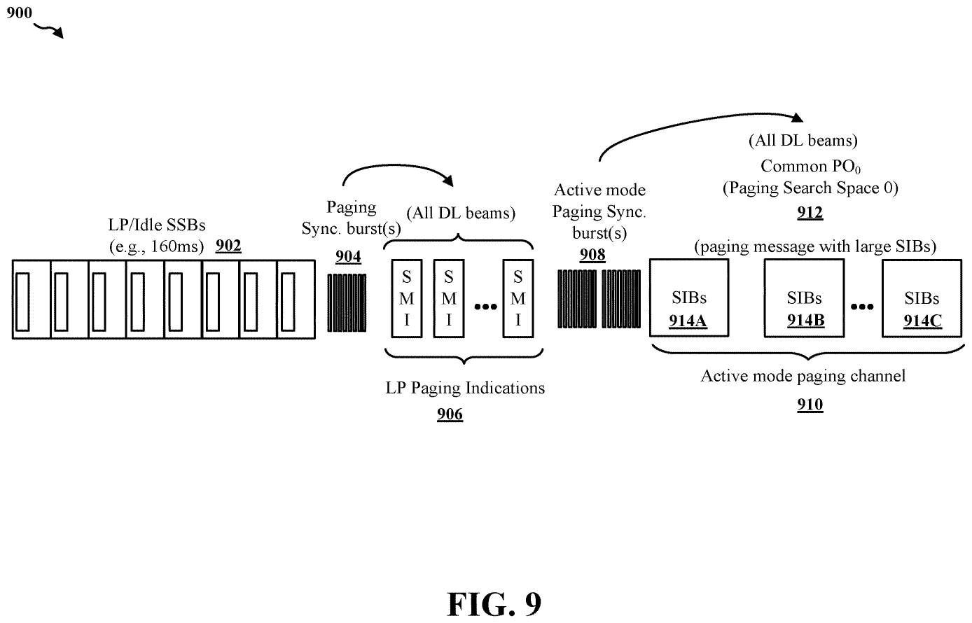

FIG. 9 is a diagram 900 illustrating example of using SMI and subsequently transitioning to an active transmission/monitoring mode, in accordance with various aspects of the present disclosure. As illustrated in FIG. 9, a set of LP SSBs 902 may be transmitted from a network node to a UE to enable synchronization while the UE is in a low-power transmission/monitoring mode (e.g., implemented using an LPR, implemented based on adjusting modes of transmission of a same radio or different radios, or the like) without the active transmission/monitoring mode (e.g., implemented using an MR, implemented based on adjusting modes of transmission of a same radio or different radios, or the like) being activated. In some aspects, the network node may also transmit one or more LP paging synchronization signal bursts 904 (e.g., synchronization signal transmissions on all down link beams in each burst for the low-power transmission/monitoring mode). Additionally, the one or more LP paging synchronization signal bursts 604 may also be used as an LP early indication for SMI (e.g., an early indication to UEs that SMI(s) 606 may be transmitted subsequently. UEs may monitor and receive SMI(s) 906 while in the low-power transmission/monitoring mode of the UE after synchronized and beam-paired or beam-tuned with the one or more LP paging synchronization signal bursts 904 (e.g., using one or more best selected or paired receiving beam(s) for the low-power transmission/monitoring mode). UE may skip monitoring SMI(s) 906 and go to sleep immediately if no one or more LP paging synchronization signal bursts 904 transmitted. The SMI(s) 906 may indicate messages in an active-mode paging message channel 910 (e.g., PDSCH), such as a first SIB 914A on a first beam associated with a first active-mode paging synchronization signal transmission within a burst (e.g., QCL type D or same spatial filter, a second SIB 914B on a second beam associated with a second active-mode paging synchronization signal transmission within a burst (e.g., QCL type D or same spatial filter, or a third SIB 914C on a third beam associated with a third active-mode paging synchronization signal transmission within a burst (e.g., QCL type D or same spatial filter, and so on. Based on the SMI(s) 906 indicate messages in the active-mode paging message channel 910, the UE may transition to the active transmission/monitoring mode and receive one or more active-mode paging synchronization signal bursts 908 (e.g., synchronization signal transmissions on all down link beams in each burst for the active transmission/monitoring mode) to facilitate reception in the active-mode paging message channel 910 (e.g., for quick synchronization or beam paring or tuning using the active transmission/monitoring mode). The first SIB 914A, the second SIB 914B, or the third SIB 914C may be included in common PO(s) 912 (e.g., a common search space such as search space 0 for paging).

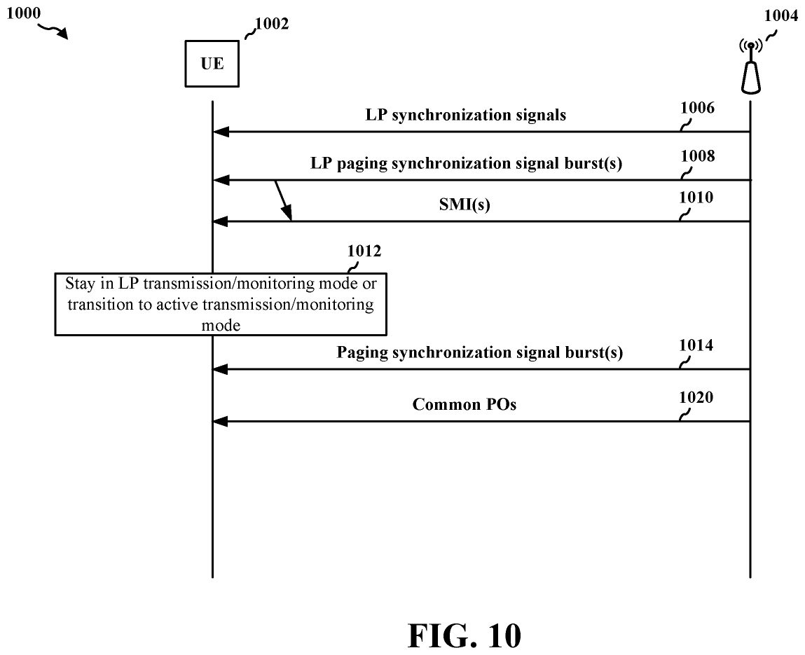

FIG. 10 is a diagram 1000 illustrating example communications between a network node 1004 and a UE 1002, in accordance with various aspects of the present disclosure. As illustrated in FIG. 10, the network node 1004 may transmit, while the UE 1002 is in a low-power transmission/monitoring mode (e.g., implemented using an LPR, implemented based on adjusting modes of transmission of a same radio or different radios, or the like) without transitioning to an active transmission/monitoring mode (e.g., implemented using an MR, implemented based on adjusting modes of transmission of a same radio or different radios, or the like), one or more LP synchronization signal bursts 1006 for quick synchronization or beam pairing or tuning using the low-power transmission/monitoring mode. The network node 1004 may transmit one or more LP paging synchronization signal bursts 1008 that may also indicate subsequent transmissions of SMI(s) 1010. The UE 1002 may receive the SMI(s) 1010 while in the low-power transmission/monitoring mode. The SMI(s) 1010 may indicate paging messages or SIBs in a set of common PO(s) 1020 (e.g., configured with a common search space such as search space 0 for paging). Based on what the SMI(s) 1010 is indicated, at 1012, the UE 1002 may stay in the low-power transmission/monitoring mode or transition to the active transmission/monitoring mode. If the UE transitions to the active transmission/monitoring mode, the UE may receive one or more active-mode synchronization signal bursts 1014 for quick synchronization or beam pairing or tuning using the active transmission/monitoring mode to receive the paging messages or SIBs in the set of common PO(s) 1020.

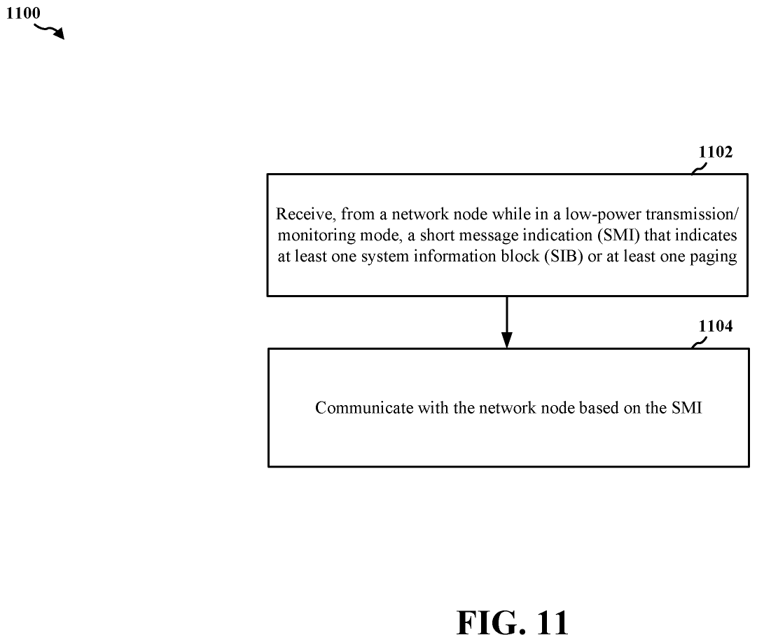

FIG. 11 is a flowchart 1100 of a method of wireless communication. The method may be performed by a UE (e.g., the UE 104, the UE 1002; the apparatus 1504). The method may improve energy consumption or latency related to paging associated with the short messages (e.g., and in particular emergency messages associated with the short messages) by using a low-power transmission/monitoring mode for cell's short messages or a combination of the low-power transmission/monitoring mode and the active transmission/monitoring mode.

At 1102, the UE may receive, from a network node while in a low-power transmission/monitoring mode, an SMI that indicates at least one SIB or at least one paging. For example, the UE 1002 may receive, from a network node 1004 while in a low-power transmission/monitoring mode (e.g., implemented using an LPR, implemented based on adjusting modes of transmission of a same radio or different radios, or the like), an SMI (e.g., 1010) that indicates at least one SIB or at least one paging. In some aspects, 1102 may be performed by paging component 198.

At 1104, the UE may communicate with the network node based on the SMI. For example, the UE 1002 may communicate (e.g., at 1014 or 1020) with the network node based on the SMI. In some aspects, 1104 may be performed by paging component 198.

In some aspects, the SMI indicates the at least one SIB, and where the at least one SIB is associated with an ETWS notification or a CMAS notification. In some aspects, to communicate with the network node based on the SMI, the UE may receive the ETWS notification or the CMAS notification while in the low-power transmission/monitoring mode. In some aspects, to communicate with the network node based on the SMI, the UE may transition to the active transmission/monitoring mode and receive the ETWS notification or the CMAS notification while in the active transmission/monitoring mode. In some aspects, the SMI indicates the at least one SIB, where the at least one SIB includes a set of idle/inactive state SIBs, a set of connected SIBs, or a set of feature SIBs. In some aspects, the SMI indicates the at least one paging, where the at least one paging is associated with a groupcast paging, a broadcast paging, or an indication of a unicast paging. In some aspects, the SMI indicates at least one subsequent SMI segment transmission including a identifier (ID) associated with the paging or a bitmap associated with a set of subgroup IDs associated with the paging. In some aspects, the UE may monitor for the SMI during a monitoring window, the at least one SIB or the at least one paging. In some aspects, to communicate with the network node based on the SMI, the UE may receive the at least one SIB or the at least one paging.

In some aspects, the monitoring window is based on a configuration of at least one of: a first starting point in a time domain, a duration in the time domain, a second starting point in a frequency domain, or a bandwidth part (BWP). In some aspects, the monitoring window may be dynamic and based on a signal quality, a battery status of the UE, or a configuration associated with the SMI. In some aspects, the SMI indicates the at least one SIB or the at least one paging based on a cyclic shift of a set of cyclic shifts, and where each cyclic shift of the set of cyclic shifts is mapped to at least one respective SIB type or at least one respective paging type. In some aspects, the SMI indicates the at least one SIB or the at least one paging based on an on-off keying (OOK) sequence associated with a bitmap of a set of bitmaps, and where each bitmap of the set of bitmaps is mapped to at least one respective SIB type or at least one respective paging type, and where a size of the bitmap is one of: (1) independent of a capability associated with the UE, (2) based on a capability associated with the UE, or (3) based on an original size and the capability associated with the UE. In some aspects, the SMI indicates the at least one SIB or the at least one paging based on an on-off keying (OOK) sequence associated with a codepoint of a set of codepoints, and where each codepoint of the set of codepoints is mapped to at least one respective SIB type or at least one respective paging type.

In some aspects, the at least one SIB or the at least one paging message is in a common PO configured for a group of UEs including the UE or all UEs in communication with the network node. In some aspects, the common PO is independent of whether the SMI indicates the at least one SIB or the at least one paging. In some aspects, the common PO is one particular common PO of a set of POs, and where each common PO of the set of common POs is associated with a respective SMI type based on at least whether a respective SMI indicates the at least one SIB or the at least one paging. In some aspects, the UE may also receive, while in the low-power transmission/monitoring mode, at least one LP paging synchronization signal burst, transition to the active transmission/monitoring mode, receive, while in the active transmission/monitoring mode, at least one active-mode paging synchronization signal burst, and monitor, while in the active transmission/monitoring mode, at least one common PO for a group of UEs including the UE.

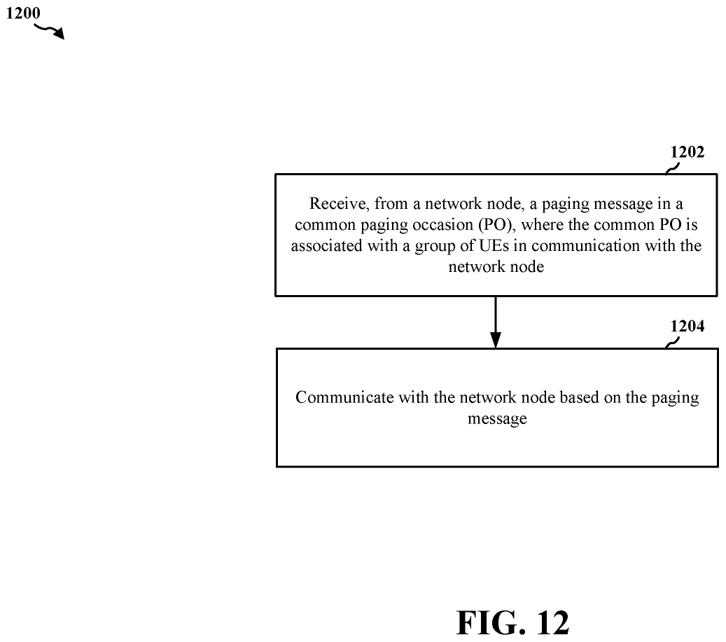

FIG. 12 is a flowchart 1200 of a method of wireless communication. The method may be performed by a UE (e.g., the UE 104, the UE 1002; the apparatus 1504). The method may improve energy consumption or latency related to paging associated with the short messages (e.g., and in particular emergency messages associated with the short messages) by using a low-power transmission/monitoring mode for cell's short messages or a combination of the low-power transmission/monitoring mode and the active transmission/monitoring mode.

At 1202, the UE may receive, from a network node, a paging message in a common PO, where the common PO is associated with a group of UEs in communication with the network node. For example, the UE 1002 may receive, from a network node 1004, a paging message (e.g., 1020) in a common PO, where the common PO is associated with a group of UEs in communication with the network node. In some aspects, 1202 may be performed by paging component 198.

At 1204, the UE may communicate with the network node based on the paging message. For example, the UE 1002 may communicate with the network node based on the paging message. In some aspects, 1204 may be performed by paging component 198.

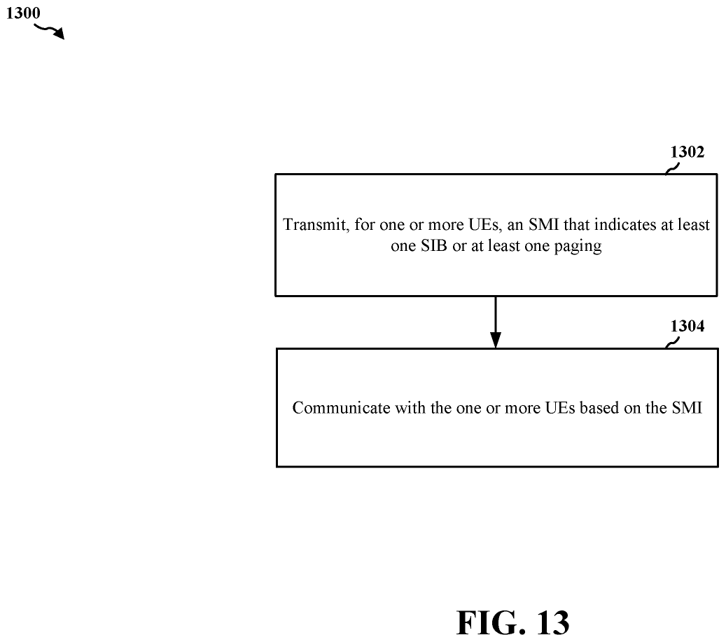

FIG. 13 is a flowchart 1300 of a method of wireless communication. The method may be performed by a network node (e.g., the base station 102, the network node 1004, the network entity 1502, the network entity 1602). The method may improve energy consumption or latency related to paging associated with the short messages (e.g., and in particular emergency messages associated with the short messages) by using a low-power transmission/monitoring mode for cell's short messages or a combination of the low-power transmission/monitoring mode and the active transmission/monitoring mode.

At 1302, the network node may transmit, for one or more UEs (e.g., a group of UEs or all UEs in communication with the network node), an SMI that indicates at least one SIB or at least one paging. For example, the network node 1004 may transmit, for one or more UEs (e.g., a group of UEs or all UEs in communication with the network node) including a UE 1002, an SMI (e.g., 1010) that indicates at least one SIB or at least one paging. In some aspects, 1302 may be performed by paging component 199.

At 1304, the network node may communicate with the one or more UEs based on the SMI. For example, the network node 1004 may communicate with the one or more UEs based on the SMI. In some aspects, 1304 may be performed by paging component 199.

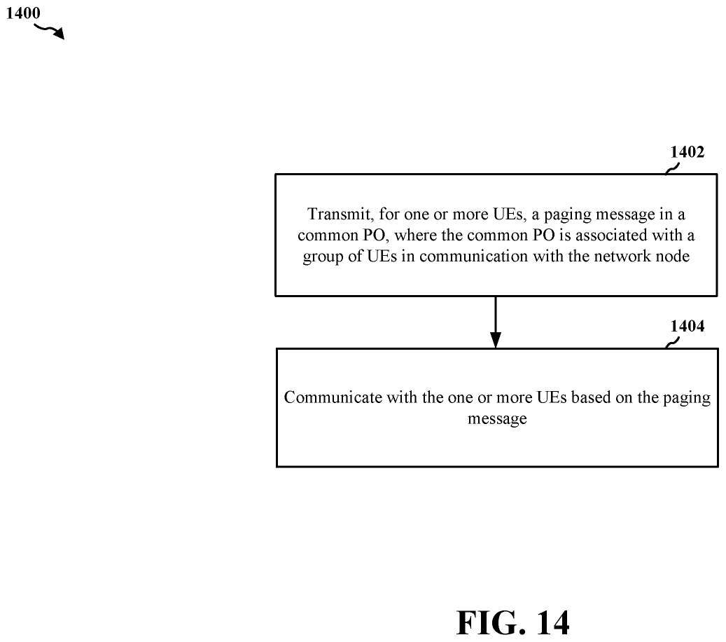

FIG. 14 is a flowchart 1400 of a method of wireless communication. The method may be performed by a network node (e.g., the base station 102, the network node 1004, the network entity 1502, the network entity 1602). The method may improve energy consumption or latency related to paging associated with the short messages (e.g., and in particular emergency messages associated with the short messages) by using a low-power transmission/monitoring mode for cell's short messages or a combination of the low-power transmission/monitoring mode and the active transmission/monitoring mode.

At 1402, the network node may transmit, for one or more UEs (e.g., a group of UEs or all UEs in communication with the network node), a paging message in a common PO, where the common PO is associated with a group of UEs in communication with the network node. For example, the network node 1004 may transmit, for one or more UEs (e.g., a group of UEs or all UEs in communication with the network node) including the UE 1002, a paging message in a common PO (e.g., 1020), where the common PO is associated with a group of UEs or all UEs in communication with the network node. In some aspects, 1402 may be performed by paging component 199.

At 1404, the network node may communicate with the one or more UEs based on the paging message. For example, the network node 1004 may communicate with one or more UEs including the UE 1002 based on the paging message (e.g., 1020). In some aspects, 1404 may be performed by paging component 199.

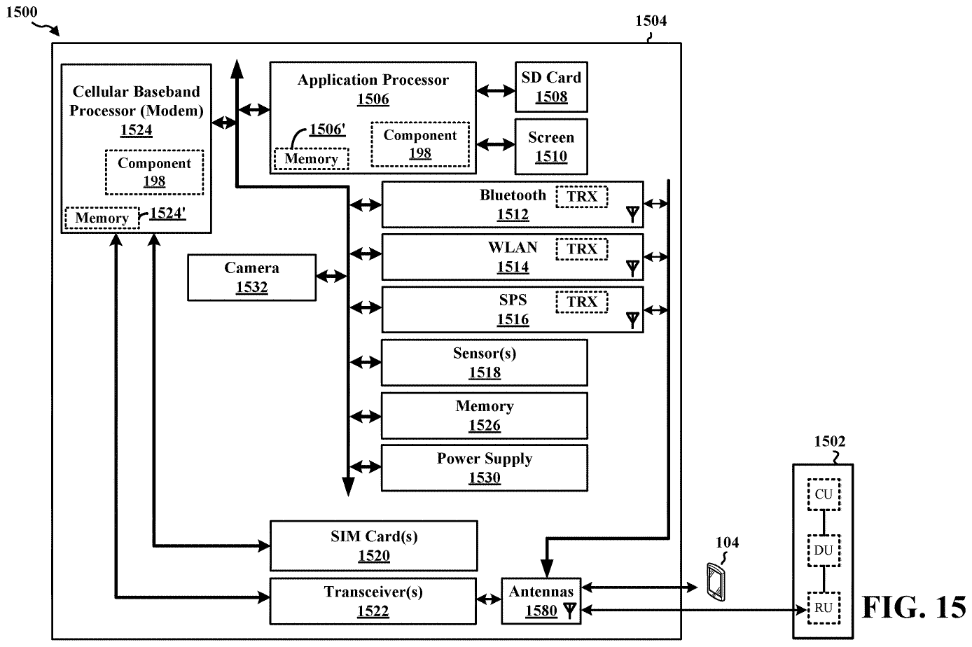

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the paging component 198 may be configured to receive, from a network node while in a low-power transmission/monitoring mode, a short message indication (SMI) that indicates at least one system information block (SIB) or at least one paging. The low-power transmission/monitoring mode may be implemented using a low-power radio (LPR) separate from or integrated with a main radio (MR), a single radio with different operating states, or transmission chains with different power amplifier configurations. In some aspects, the paging component 198 may be further configured to communicate with the network node based on the SMI. In some aspects, the paging component 198 may be configured to receive, from a network node, a paging message in a common paging occasion (PO), where the common PO is associated with a group of UEs or all UEs in communication with the network node. In some aspects, the paging component 198 may be further configured to communicate with the network node based on the paging message. The paging component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving, from a network node while in a low-power transmission/monitoring mode, a short message indication (SMI) that indicates at least one system information block (SIB) or at least one paging. In some aspects, the apparatus 1504 may include means for communicating with the network node based on the SMI. In some aspects, the apparatus 1504 may include means for receiving the ETWS notification or the CMAS notification while in the low-power transmission/monitoring mode. In some aspects, the apparatus 1504 may include means for transitioning to the active transmission/monitoring mode and receiving the ETWS notification or the CMAS notification while in i the active transmission/monitoring mode. In some aspects, the apparatus 1504 may include means for monitoring for, based on the SMI during a monitoring window, the at least one SIB or the at least one paging. In some aspects, the apparatus 1504 may include means for receiving the at least one SIB or the at least one paging during the monitoring window. In some aspects, the apparatus 1504 may include means for receiving, while in the low-power transmission/monitoring mode, at least one LP paging synchronization signal burst. In some aspects, the apparatus 1504 may include means for receiving, while in the active transmission/monitoring mode, at least one active-mode paging synchronization signal burst. In some aspects, the apparatus 1504 may include means for monitoring, while in the active transmission/monitoring mode, at least one common PO for a group of UEs including the UE or all UEs in communication with the network node. In some aspects, the apparatus 1504 may include means for receiving, from a network node, a paging message in a common PO, where the common PO is associated with a group of UEs or all UEs in communication with the network node. In some aspects, the apparatus 1504 may include means for communicating with the network node based on the paging message. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

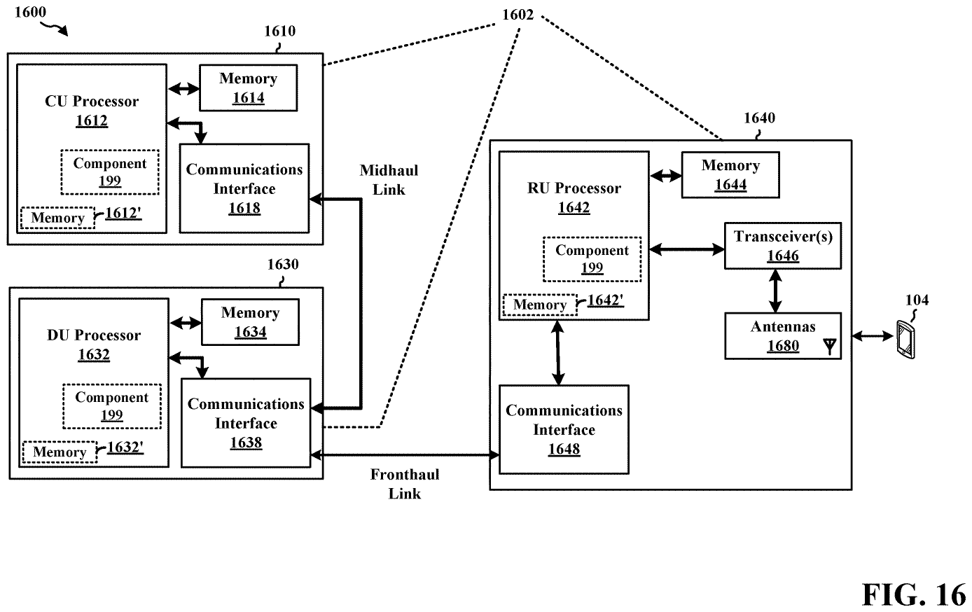

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the paging component 199 may be configured to transmit, for one or more UEs (e.g., a group of UEs or all UEs in communication with the network node), an SMI that indicates at least one SIB or at least one paging. In some aspects, the paging component 199 may be further configured to communicate with the one or more UEs based on the SMI. In some aspects, the paging component 199 may be configured to transmit, for one or more UEs (e.g., a group of UEs or all UEs in communication with the network node), a paging message in a common PO, where the common PO is associated with a group of UEs or all UEs in communication with the network node. In some aspects, the paging component 199 may be further configured to communicate with the one or more UEs based on the paging message. The paging component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting, for one or more UEs (e.g., a group of UEs or all UEs in communication with the network node), an SMI that indicates at least one SIB or at least one paging. In some aspects, the network entity 1602 may include means for communicating with the one or more UEs based on the SMI. In some aspects, the network entity 1602 may include means for transmitting, for one or more UEs (e.g., a group of UEs or all UEs in communication with the network node), a paging message in a common PO, where the common PO is associated with a group of UEs or all UEs in communication with the network node. In some aspects, the network entity 1602 may include means for communicating with the one or more UEs based on the paging message. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is an apparatus for wireless communication at a user equipment (UE), including: at least one memory; and at least one processor coupled to the at least one memory, based at least in part on information stored in the at least one memory, the at least one processor is configured to: receive, from a network node while in a low-power transmission/monitoring mode, a short message indication (SMI) that indicates at least one system information block (SIB) or at least one paging; and communicate with the network node based on the SMI.
Aspect 2 is the apparatus of aspect 1, where the SMI indicates the at least one SIB, and where the at least one SIB is associated with an earthquake and tsunami warning system (ETWS) notification or a commercial mobile alert system (CMAS) notification.
Aspect 3 is the apparatus of aspect 2, where to communicate with the network node based on the SMI, the at least one processor is configured to: receive the ETWS notification or the CMAS notification while in the low-power transmission/monitoring mode.
Aspect 4 is the apparatus of any of aspects 2-3, where to communicate with the network node based on the SMI, the at least one processor is configured to: transition to an active transmission/monitoring mode; and receive the ETWS notification or the CMAS notification while in the active transmission/monitoring mode.
Aspect 5 is the apparatus of any of aspects 1-4, where the SMI indicates the at least one SIB, where the at least one SIB includes a set of idle/inactive state SIBs, a set of connected SIBs, or a set of feature SIBs.
Aspect 6 is the apparatus of any of aspects 1-5, where the SMI indicates the at least one paging, where the at least one paging is associated with a groupcast paging, a broadcast paging, or an indication of a unicast paging.
Aspect 7 is the apparatus of aspect 6, where the SMI indicates at least one subsequent SMI segment transmission including an identifier (ID) associated with the groupcast paging or the broadcast paging, or a bitmap associated with a set of subgroup IDs associated with the unicast paging.
Aspect 8 is the apparatus of any of aspects 1-7, where the at least one processor is configured to: monitor for the SMI during a monitoring window.
Aspect 9 is the apparatus of aspect 8, where the monitoring window is based on a configuration of at least one of: a first starting point in a time domain, a duration in the time domain, a second starting point in a frequency domain, or a bandwidth part (BWP).
Aspect 10 is the apparatus of any of aspects 1-9, where to communicate with the network node based on the SMI, the at least one processor is configured to: receive the at least one SIB or the at least one paging.
Aspect 11 is the apparatus of any of aspects 1-10, where the SMI indicates the at least one SIB or the at least one paging based on a cyclic shift of a set of cyclic shifts, and where each cyclic shift of the set of cyclic shifts is mapped to at least one respective SIB type or at least one respective paging type.
Aspect 12 is the apparatus of any of aspects 1-13, where the SMI indicates the at least one SIB or the at least one paging based on an on-off keying (OOK) sequence associated with a bitmap of a set of bitmaps, and where each bitmap of the set of bitmaps is mapped to at least one respective SIB type or at least one respective paging type.
Aspect 13 is the apparatus of any of aspects 1-12, where the SMI indicates the at least one SIB or the at least one paging based on an on-off keying (OOK) sequence associated with a codepoint of a set of codepoints, and where each codepoint of the set of codepoints is mapped to at least one respective SIB type or at least one respective paging type.
Aspect 14 is the apparatus of any of aspects 1-13, where the at least one SIB or the at least one paging message is in a common paging occasion (PO) configured for a group of UEs including the UE or all UEs in communication with the network node.
Aspect 15 is the apparatus of aspect 14, where the common PO is independent of whether the SMI indicates the at least one SIB or the at least one paging.
Aspect 16 is the apparatus of any of aspects 14-15, where the common PO is one particular common PO of a set of POs, and where each common PO of the set of common POs is associated with a respective SMI type based on at least whether a respective SMI indicates the at least one SIB or the at least one paging.
Aspect 17 is the apparatus of any of aspects 1-16, where the at least one processor is further configured to: receive, while in the low-power transmission/monitoring mode, at least one low-power paging synchronization signal burst; transition to an active transmission/monitoring mode; receive, while in the active transmission/monitoring mode, at least one active-mode paging synchronization signal burst; and monitor, while in the active transmission/monitoring mode, at least one common paging occasion (PO) for a group of UEs including the UE or all UEs in communication with the network node.
Aspect 18 is an apparatus for wireless communication at a user equipment (UE), including: at least one memory; and at least one processor coupled to the at least one memory, based at least in part on information stored in the at least one memory, the at least one processor is configured to: receive, from a network node, a paging message in a common paging occasion (PO), where the common PO is associated with a group of UEs or all UEs in communication with the network node; and communicate with the network node based on the paging message.
Aspect 19 is the apparatus of aspect 18, where the at least one processor is further configured to: monitor a common search space associated with the common PO for the paging message.
Aspect 20 is the apparatus of any of aspects 18-19, where the paging message comprises at least one SIB associated with an emergency notification, a system information update, or a public warning system (PWS) alert.
Aspect 21 is the apparatus of any of aspects 18-20, where the at least one processor is further configured to: receive, while in a low-power transmission/monitoring mode or an active transmission/monitoring mode, a synchronization signal burst prior to the common PO.
Aspect 22 is an apparatus for wireless communication at a network node, including: at least one memory; and at least one processor coupled to the at least one memory, based at least in part on information stored in the at least one memory, the at least one processor is configured to: transmit, for one or more user equipments (UEs), a short message indication (SMI) that indicates at least one system information block (SIB) or at least one paging; and communicate with the one or more UEs based on the SMI.
Aspect 23 is the apparatus of aspect 22, where the at least one processor is configured to: transmit the SMI via a set of downlink beams associated with a low-power radio (LPR) configuration.
Aspect 24 is the apparatus of any of aspects 22-23, where the SMI comprises an on-off keying (OOK) sequence, a cyclic shift, or a bitmap mapped to a type of the at least one SIB or the at least one paging.
Aspect 25 is the apparatus of any of aspects 22-24, where the at least one processor is configured to: transmit at least one low-power (LP) paging synchronization signal burst prior to transmitting the SMI.
Aspect 26 is an apparatus for wireless communication at a network node, including: at least one memory; and at least one processor coupled to the at least one memory, based at least in part on information stored in the at least one memory, the at least one processor is configured to: transmit, for one or more user equipments (UEs), a paging message in a common paging occasion (PO), where the common PO is associated with a group of UEs or all UEs in communication with the network node; and communicate with the one or more UEs based on the paging message.
Aspect 27 is the apparatus of aspect 26, where the at least one processor is configured to: configure the common PO within a common search space shared by the group of UEs or all UEs.
Aspect 28 is the apparatus of any of aspects 26-27, where the paging message is transmitted via a main radio (MR) paging message channel or a low-power radio (LPR) paging message channel.
Aspect 29 is the apparatus of any of aspects 26-28, where the at least one processor is configured to: transmit the paging message using a single frequency network (SFN) transmission scheme or a joint transmission scheme from a plurality of transmission reception points (TRPs).
Aspect 30 is a method of wireless communication for implementing any of aspects 1 to 21.
Aspect 31 is a computer-readable medium (e.g., a non-transitory computer-readable medium) storing computer executable code, the code when executed by at least one processor causes the at least one processor to implement any of aspects 1 to 21.
Aspect 32 is an apparatus comprising means for implementing any of aspects 1 to 21.
Aspect 33 is a method of wireless communication for implementing any of aspects 22 to 29.
Aspect 34 is a computer-readable medium (e.g., a non-transitory computer-readable medium) storing computer executable code, the code when executed by at least one processor causes the at least one processor to implement any of aspects 22 to 29.
Aspect 35 is an apparatus comprising means for implementing any of aspects 22 to 29.

What is claimed is:

1. An apparatus for wireless communication at a user equipment (UE), comprising:
at least one memory; and
at least one processor coupled to the at least one memory, based at least in part on information stored in the at least one memory, the at least one processor is configured to:
receive, from a network node while in a low-power transmission/monitoring mode, a short message indication (SMI) that indicates at least one system information block (SIB) or at least one paging; and
communicate with the network node based on the SMI.

2. The apparatus of claim 1, wherein the SMI indicates the at least one SIB, and wherein the at least one SIB is associated with an earthquake and tsunami warning system (ETWS) notification or a commercial mobile alert system (CMAS) notification.

3. The apparatus of claim 2, wherein to communicate with the network node based on the SMI, the at least one processor is configured to:
receive the ETWS notification or the CMAS notification while in the low-power transmission/monitoring mode.

4. The apparatus of claim 2, wherein to communicate with the network node based on the SMI, the at least one processor is configured to:
transition to an active transmission/monitoring mode; and
receive the ETWS notification or the CMAS notification while in the active transmission/monitoring mode.

5. The apparatus of claim 1, wherein the SMI indicates the at least one SIB, wherein the at least one SIB comprises a set of idle/inactive state SIBs, a set of connected SIBs, or a set of feature SIBs.

6. The apparatus of claim 1, wherein the SMI indicates the at least one paging, wherein the at least one paging is associated with a groupcast paging, a broadcast paging, or an indication of a unicast paging.

7. The apparatus of claim 6, wherein the SMI indicates at least one subsequent SMI segment transmission comprising a identifier (ID) associated with the groupcast paging or the broadcast paging, or a bitmap associated with a set of subgroup IDs associated with the unicast paging.

8. The apparatus of claim 1, wherein the at least one processor is configured to:
monitor for the SMI during a monitoring window.

9. The apparatus of claim 8, wherein the monitoring window is based on a configuration of at least one of: a first starting point in a time domain, a duration in the time domain, a second starting point in a frequency domain, or a bandwidth part (BWP).

10. The apparatus of claim 1, wherein to communicate with the network node based on the SMI, the at least one processor is configured to:
receive the at least one SIB or the at least one paging.

11. The apparatus of claim 1, wherein the SMI indicates the at least one SIB or the at least one paging based on a cyclic shift of a set of cyclic shifts, and wherein each cyclic shift of the set of cyclic shifts is mapped to at least one respective SIB type or at least one respective paging type.

12. The apparatus of claim 1, wherein the SMI indicates the at least one SIB or the at least one paging based on an on-off keying (OOK) sequence associated with a bitmap of a set of bitmaps, and wherein each bitmap of the set of bitmaps is mapped to at least one respective SIB type or at least one respective paging type.

13. The apparatus of claim 1, wherein the SMI indicates the at least one SIB or the at least one paging based on an on-off keying (OOK) sequence associated with a codepoint of a set of codepoints, and wherein each codepoint of the set of codepoints is mapped to at least one respective SIB type or at least one respective paging type.

14. The apparatus of claim 1, wherein the at least one SIB or the at least one paging message is in a common paging occasion (PO) configured for a group of UEs including the UE or all UEs in communication with the network node.

15. The apparatus of claim 14, wherein the common PO is independent of whether the SMI indicates the at least one SIB or the at least one paging.

16. The apparatus of claim 14, wherein the common PO is one particular common PO of a set of POs, and wherein each common PO of the set of common POs is associated with a respective SMI type based on at least whether a respective SMI indicates the at least one SIB or the at least one paging.

17. The apparatus of claim 1, wherein the at least one processor is further configured to:
receive, while in the low-power transmission/monitoring mode, at least one low-power paging synchronization signal burst;
transition to an active transmission/monitoring mode;
receive, while in the active transmission/monitoring mode, at least one active-mode paging synchronization signal burst; and
monitor, while in the active transmission/monitoring mode, at least one common paging occasion (PO) for a group of UEs including the UE or all UEs in communication with the network node.

18. An apparatus for wireless communication at a user equipment (UE), comprising:
at least one memory; and
at least one processor coupled to the at least one memory, based at least in part on information stored in the at least one memory, the at least one processor is configured to:
receive, from a network node, a paging message in a common paging occasion (PO), wherein the common PO is associated with a group of UEs or all UEs in communication with the network node; and
communicate with the network node based on the paging message.

19. An apparatus for wireless communication at a network node, comprising:
at least one memory; and
at least one processor coupled to the at least one memory, based at least in part on information stored in the at least one memory, the at least one processor is configured to:
transmit, for one or more user equipments (UEs), a short message indication (SMI) that indicates at least one system information block (SIB) or at least one paging; and
communicate with the one or more UEs based on the SMI.

20. An apparatus for wireless communication at a network node, comprising:
at least one memory; and
at least one processor coupled to the at least one memory, based at least in part on information stored in the at least one memory, the at least one processor is configured to:
transmit, for one or more user equipments (UEs), a paging message in a common paging occasion (PO), wherein the common PO is associated with a group of UEs or all UEs in communication with the network node; and
communicate with the one or more UEs based on the paging message.
